(19) United States
(12) Patent Application Publication
(10) Pub. No.: US 2023/0316389 A1
(43) Pub. Date: Oct. 5, 2023

(54) SYSTEM AND METHOD FOR AN ONLINE MARKETPLACE

(71) Applicant: MINTLIST TECHNOLOGIES INC., Vancouver (CA)

(72) Inventors: Edward Alexander KAWAS, Vancouver (CA); Vishal TALREJA, Vancouver (CA); Mehrsa RAEISZADEH, Vancouver (CA); Michael Charles WOOD, Vancouver (CA)

(21) Appl. No.: 18/129,796

(22) Filed: Mar. 31, 2023

Related U.S. Application Data
(60) Provisional application No. 63/326,241, filed on Mar. 31, 2022.

(51) Int. Cl. G06Q 30/08; G06Q 30/0283; G06Q 30/0601

(52) U.S. Cl. CPC G06Q 30/08; G06Q 30/0283; G06Q 30/0627

(57) ABSTRACT

The embodiments generally relate to systems and methods for an online marketplace for goods and services. The systems and methods involve a hardware processor that receives attributes for a good or service from the seller terminal, generates pricing data for the good or service using a price estimator and market analyser, and processes the attributes for the good or service using a condition analyzer. The systems and methods facilitate a product or service listing using an interface between a seller terminal and at least one of a dealer terminal, and a buyer terminal to generate and provide a listing for the product or service. The systems and methods can facilitate a product or service listing using an interface between a seller terminal and at least one of a dealer terminal, and a buyer terminal with an auction/transaction conductor to list the product or service, including in an auction in some embodiments. The hardware processor receives a plurality of bids or offers, assess bids or offers, and determines whether there is an accepted bid or offer. The interface provides visualizations of the good or service based on the attributes. The hardware processor generates a smart contract for the good or service using the smart contract generator in response to receiving confirmation from the seller terminal for the accepted bid or offer.

### FIELD

The improvements generally relate to the field of computer implemented systems and methods for an online marketplace to buy, sell, and/or trade different goods and services. The improvements relate to systems and methods involving automatic pricing and negotiation tools, machine vision and image processing tools, as well as interactive interfaces having improved visualizations of goods and services.

### INTRODUCTION

An online marketplace or auction can facilitate the purchase and sale of different goods and services. An online marketplace is an e-commerce platform for multiple third parties to exchange goods and services. There exists a need for an improved online marketplace, and improved tools to support the online marketplace, or at least alternatives.

### SUMMARY

In an aspect, embodiments described herein provide systems and methods for an online marketplace or auction for the purchase and sale of goods and services.

In accordance with an aspect, there is provided a system for an online marketplace for goods and services. The system includes a non-transitory memory storing instructions having an interface for a seller terminal, a dealer terminal, and a buyer terminal, and a hardware processor. The hardware processor executes the instructions to receive attributes for a product or service from the seller terminal, process the attributes for the product or service using a condition analyzer, generate pricing data for the product or service using a price estimator and a market analyser, facilitate a product or service listing using the interface between the seller terminal and at least one of the dealer terminal, and the buyer terminal using an auction/transaction conductor to list the product or service, receive a plurality of bids or offers, assess bids or offers, and determine whether there is an accepted bid or offer, update the interface to provide visualizations of the product or service based on the attributes, and generate a smart contract for the product or service using the smart contract generator in response to receiving confirmation from the seller terminal for the accepted bid or offer.

In accordance with a further aspect, the price estimator includes a product characteristics determiner to determine the product or service characteristics based in part on the attributes for the product or service, a historic price data retriever to retrieve historic price data of products or service with similar characteristics to the product or service characteristics, and a dynamic price generator to dynamically generate a price based in part on the product or service characteristics and the historic price data.

In accordance with a further aspect, the price estimator further includes a recommendation generator, and the hardware processor provides recommendations on acceptance of a bid or offer based on the attributes for the product or service using the recommendation generator.

In accordance with a further aspect, the price estimator includes a counteroffer generator to generate counteroffers to bids or offers.

In accordance with a further aspect, the visualizations of the product or service are provided in an augmented or virtual reality format.

In accordance with a further aspect, the condition analyzer includes a product characteristics receiver to receive the attributes for the product or service, a product image fault determiner to diagnose product or service faults based on visual input of the product or service, and a fault report generator to provide feedback on the product or service based in part on the attributes and the diagnosed product or service faults.

In accordance with a further aspect, the condition analyzer further includes a product audio determiner to diagnose product or service faults based on audio input of the product or service.

In accordance with a further aspect, the pricing data for the product or service is based in part on the feedback on the product or service.

In accordance with a further aspect, the system further includes an insurance quote or warranty and sale provider to accept information on a buyer and on the attributes for the product or service to facilitate the quote and sale of insurance or warranty on the product or service to the buyer.

In accordance with a further aspect, the system further includes a finance and lease provider to accept information on a buyer and on the attributes for the product or service to facilitate the provision of financing options for the product or service to the buyer.

In accordance with another aspect, there is provided a method for an online marketplace. The method includes receiving attributes for a product or service, processing the attributes for the product or service using a hardware processor, generating pricing data for the product or service using the hardware processing, facilitating a product or service listing using an interface between a seller terminal and at least one of a dealer terminal and a buyer terminal using an auction/transaction conductor to list the product or service, receive a plurality of bids or offers, assess bids or offers, and determine whether there is an accepted bid or offer, updating the interface to provide visualizations of the product or service based on the attributes, and generating a smart contract for the product or service in response to receiving confirmation from the seller terminal for the accepted bid or offer.

In accordance with a further aspect, the generating pricing data further includes determining the product or service characteristics based in part on the attributes for the product or service, retrieving historic price data of products or service with similar characteristics to the product or service characteristics, and dynamically generating a price based in part on the product or service characteristics and the historic price data.

In accordance with a further aspect, the assess bids or offers includes providing recommendations on acceptance of a bid or offer based on the attributes for the product or service.

In accordance with a further aspect, the method further includes generating counteroffers to bids or offers.

In accordance with a further aspect, the visualizations of the product or service are provided in an augmented or virtual reality format.

In accordance with a further aspect, the generating pricing data includes receiving the attributes for the product or service, diagnosing product or service faults based on visual input of the product or service, and providing feedback on the product or service based in part on the attributes and the diagnosed product or service faults.

In accordance with a further aspect, the generating pricing data further includes diagnosing product or service faults based on audio input of the product or service.

In accordance with a further aspect, the pricing data is based in part on the feedback on the product or service.

In accordance with a further aspect, the method further includes accepting information on a buyer, facilitating the quote and sale of insurance or warranty on the product or service to the buyer.

In accordance with a further aspect, the method further includes accepting information on a buyer, and facilitating the provision of financing options for the product or service to the buyer.

In accordance with another aspect, there is provided a system for an online marketplace for goods and services. The system includes a non-transitory memory storing instructions having an interface for a seller terminal, a dealer terminal, and a buyer terminal, and a hardware processor. The hardware processor executes the instructions to receive attributes for a product or service from the seller terminal, process the attributes for the product or service using a condition analyzer, generate pricing data for the product or service using a price estimator and a market analyser, facilitate a product or service listing using the interface between the seller terminal and at least one of the dealer terminal, and the buyer terminal using an auction/transaction conductor to list the product or service, receive a plurality of bids or offers, assess bids or offers, and determine whether there is an accepted bid or offer, and update the interface to provide visualizations of the product or service in an augmented or virtual reality format based on the attributes.

In accordance with another aspect, there is provided a method for an online marketplace. The method includes receiving attributes for a product or service, processing the attributes for the product or service using a hardware processor, generating pricing data for the product or service using the hardware processing, facilitating a product or service listing using an interface between a seller terminal and at least one of a dealer terminal and a buyer terminal using an auction/transaction conductor to list the product or service, receive a plurality of bids or offers, assess bids or offers, and determine whether there is an accepted bid or offer, and updating the interface to provide visualizations of the product or service in an augmented or virtual reality format based on the attributes.

Many further features and combinations thereof concerning embodiments described herein will appear to those skilled in the art following a reading of the instant disclosure.

### DESCRIPTION OF THE FIGURES

In the figures,

FIG. 1 illustrates an example system for an online marketplace for goods and services according to some embodiments.

FIG. 2 illustrates an example of a price estimator, according to some embodiments.

FIG. 3 illustrates an example condition analyzer, according to some embodiments.

FIG. 4 illustrates an example process diagram for listing a product in the online marketplace, according to some embodiments.

FIG. 5 illustrates an example process diagram for purchasing a product in the online marketplace, according to some embodiments.

FIG. 6 illustrates an example process diagram for coordinating an exchange as a dealer, according to some embodiments.

FIG. 7 illustrates an example instructional photo used to assist the seller in obtaining the requisite images to generate AR/VR content, according to some embodiments.

FIG. 8 illustrates a schematic diagram of an example computing device suitable for implementing the system in FIG. 1, according to some embodiments.

### DETAILED DESCRIPTION

An online marketplace or auction can facilitate the purchase and sale of different goods and services. An online marketplace is an e-commerce platform for multiple third parties to exchange goods and services. There exists a need for an improved online marketplace, and improved tools to support the online marketplace.

Embodiments described herein relate to systems and methods for an online marketplace for the purchase, sale, and/or trading of different goods and services. Embodiments described herein relate to automatic pricing and negotiation tools, machine vision and image processing tools, natural language processing tools, communication interfaces, and interactive visual interfaces for different stakeholders with visualizations of the goods and services, or related data such as offers or bids.

Some embodiments of the online marketplace described herein can enable a user to buy, sell, or trade any asset (e.g. product, service), or different types of assets. Some embodiments are directed specifically to buying, selling, or trading any asset with a serial number (e.g., vehicles, boats, high-end jewelry, electronics, jets, motorsports, arts etc.). A serial number can be assigned to each individual asset in order to distinguish that asset from all others. The serial number can be unique to a specific asset. A serial number is not limited to numerals, and can contain letters or other symbols. Some embodiments may buy, sell, and trade any authentic physical asset that has a valid serial number. Some embodiments of the online marketplace include an asset valuation system that enables users to value non-parity assets and trade or exchange them against the purchase of another asset (e.g., trading in a house for a jet plane). The serial number is an example attribute of the product or service.

Some embodiments may sell one product or service type (e.g., vehicles, cars, or automobiles), but enable trade-ins for other types of products or services. In some embodiments, the trade-ins may be limited to authentic physical assets that include a valid serial number. In embodiments where one asset type (or type of product or service) is sold (e.g., vehicles) then serial numbers related to these products (i.e., Vehicle Identification Numbers (VINs)) may be stored in a separate database from the serial number associated with trade-ins of other product or service types.

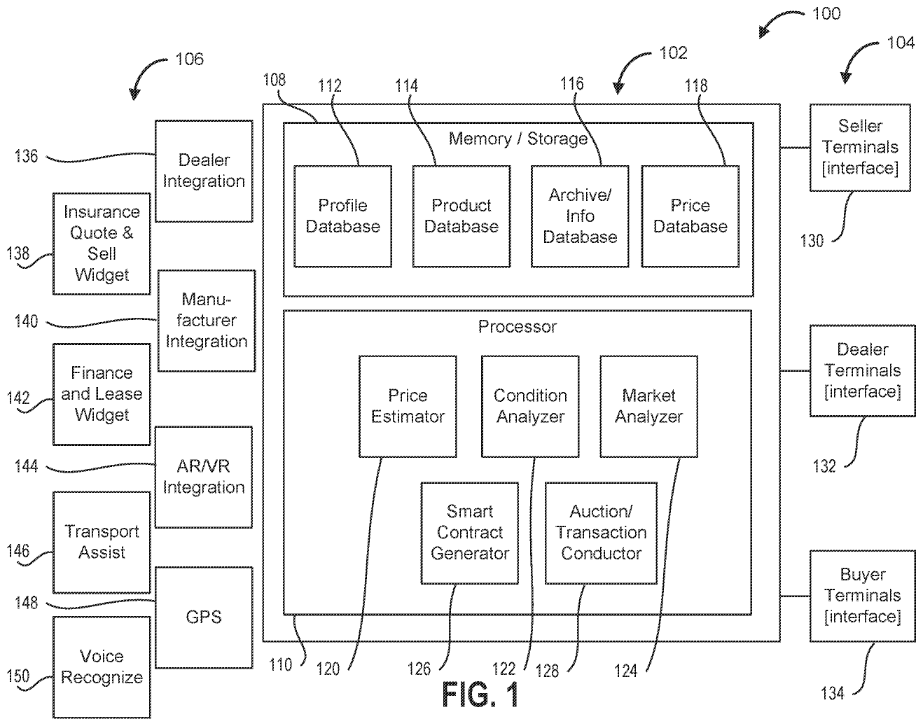

FIG. 1 illustrates an example system for an online marketplace for goods and services according to some embodiments.

System 100 can include a platform 102, terminals 104, and external widgets 106. The terminals 104 can interoperate with platform 102 and provide user interfaces to, for example, the buyer, sellers, traders, and/or dealers. The terminals 104 can include computer hardware such as a hardware processor, display, and memory, and can have an interface to communicate with the platform 102 to exchange data and comments, and the interface can provide visualizations of products or services, along with related data. The external widgets 106 can interoperate with third-party providers to provide additional functionality to platform 102. The external widgets 106 are applications or code element.

The terms buyer and seller can include a trader and/or dealer as appropriate. The term seller is generally used to indicate a user listing something for auction or sale on the platform and the term buyer is used generally to indicate a user seeking to purchase, acquire, bid, or make an offer on a listing. Functionalities generally associated with buyers and sellers are also generally available to traders and dealers. For example, a trader may both list an item and acquire an item as part of a trade.

Platform 102 involves computer hardware. For example, platform 102 can involve a memory 108 and a processor 110. Platform 102 can be the system capable of providing an online marketplace for goods and services. Buyer and sellers may interact with the platform 102 through the terminals 104 having interfaces to list, bid, make offers on, buy, or sell products and services in platform 102. Dealers may purchase and resell goods and services or facilitate the exchange of goods and services through the platform.

Memory 108 is configured to store various data utilized by platform 102. Memory 108 may implement a conventional relational or object-oriented database, such as Microsoft SQL Server, Oracle, DB2, Sybase, Pervasive, MongoDB, NoSQL, or the like. Memory 108 can include, for example, profile database 112, product database 114, archive/info database 116, and price database 118.

Profile database 112 can store the profiles of, for example, sellers, dealers, and buyers. In some embodiments, the profile types (e.g., seller, dealer, and buyer) will have access to different functionalities within platform 102. For example, only dealer profiles may be permitted to engage in exchange mediation as between buyers and sellers. In some embodiments, the profile types may in part determine information required before permitting the user to access platform 102. For example, some dealer profiles may require registration and proof of regulatory credentials before permitting a dealer to access the platform 102. In some embodiments, profile database 112 can also be used by users to look up information about other users (e.g., potential buyers can lookup potential sellers' ratings or previous buyer satisfaction scores). The profiles of sellers or dealers can store a plurality of items or inventory data.

Product database 114 can store the information relevant to the products and services for sale. Product database 114 can store attributes for different products and services. For example, information relevant to product can include product specification data. Product database 114 may be limited to products or services that are currently for sale, or it may retain records of previously sold products and services. For example, when selling a product with a serial number, the product database 114 may retain a record and make this transaction record available should that same product come up for sale a second time. The product database 114 can store the product or service attributes or information as well as any visual depictions and any fault reports generated by condition analyzer 122. In some embodiments, the product database 114 can be updated regarding any product or event during its ownership by a user (e.g., a user can report an accident with their vehicle while they still own it and before they have an intention to sell).

Archive/info database 116 can store archival information related to transactions facilitated through platform 102. For example, archive/info database 116 can store profile details of buyers, sellers, and any dealers involved in a transaction. Archive/info database 116 may also store the serial number of any products exchanged.

Price database 118 can store historic price data for products and services exchanged on platform 118. Price database 118 may also be configured to store market information from third-party marketplaces retrieved by market analyzer 124. The historic price data may include historic auction or sale history from system 100 (accepted or rejected) for similar products or services in similar locations and conditions. The historic data stored on price database 118 may make the historic prices available to price estimator 120 to enhance the accuracy of its price estimates. In some embodiments, users may retrieve historic price data from sales to get a price prescription before purchase/bid. These historic prices may be used to generate a price guide for used products (e.g., vehicles).

Processor 110 may be configured to execute the functionality of platform 102. Processor 110 can execute code to implement price estimator 120, condition analyzer 122, market analyzer 124, smart contract generator 126, and auction/transaction conductor 128.

Price estimator 120 can be configured to provide price estimates of products and services for a variety of applications on platform 102. Price estimator 120 can be used by sellers to determine the sale or auction price that they will list a product or service at. Price estimator 120 can be used by buyers and dealers to determine whether the price that a product or service has been listed at reflects a reasonable market price. Price estimator 120 can be used to assist sellers in determining the amount of a counteroffer to make in response to a bid or offer. Price estimator 120 can be used by buyers and dealers to determine whether they should accept the counteroffer from the seller.

In some embodiments, price estimator 120 can use the product or service attributes or details to generate a price estimate. In some embodiments, price estimator 120 can use historic price data to generate a price estimate. In some embodiments, price estimator 120 may make use of current product or service availability or rarity to estimate the price of a product or service. In embodiments wherein price estimator 120 is used to generate a counteroffer, price estimator 120 may make use of information about the bidder/offeror to generate the counteroffer (e.g., the bidder's/offeror's desire, previous counteroffer information, etc.).

Condition analyzer 122 can be used to analyze the condition of a product or service. When a seller enters their product or service information (e.g. attributes), condition analyzer 122 may use this information to estimate the condition of the product or service (e.g., mileage and age may be combined to ascertain the condition of a vehicle). In some embodiments, condition analyzer 122 may also be configured to assess a product or service through more direct diagnostic tests. For example, condition analyzer 122 may be configured to receive audio and/or visual information about the product or service and may estimate the condition based in part on this information. In some embodiments, the condition analyzer 122 can modify the image or update the characteristics based on the attributes received and the estimated conditions.

In some embodiments, condition analyzer 122 can implement an automated vehicle specification data analysis and mapping. In some embodiments, condition analyzer 122 can have a machine learning model to process vehicle specification data, such as a model based on linear regression and/or decision trees, for example. Other types of machine learning models can also be used to process technical vehicle specification information and translates to consumer use cases. For example, condition analyzer 122 can be used to process input data (e.g. 80 cu feet of storage space) to convert/translate to different parameters for customer use cases (e.g. 2 Large bags, 1 Small carry on as luggage space) to generate output data at an interface that a consumer can easily comprehend. The condition analyzer 122 generates a mapping between vehicle specification data and customer use case data. The condition analyzer 122 uses the mapping to convert or translate vehicle specification data to customer use case data, or to convert or translate customer use case data to vehicle specification data.

This may involve machine learning from base data models that ingest multiple specification data formats from multiple data vendors to build a baseline for several data points including engine capacity, horsepower, torque, interior space, storage space, wheel base and more. This data is then mapped to real-world consumer friendly data interests and uses cases that consumers are interested in, such as for example, the ability to carry X number of bags, transport pets, carry sports equipment, bikes etc.

In some embodiments, condition analyzer 122 can implement a data mapping layer between specification data and consumer facing information. The condition analyzer 122 can implement an ETL function for loading data, translating data using machine learning to define what user data structures the car data can be mapped to (e.g. small dogs, bike). The condition analyzer 122 can convert the specification data to use cases by mapping vehicle specification data to consumer facing data (user scenario variables). Towing capacity is another example.

In some embodiments, the condition analyzer 122 can receive product characteristics as attributes for the product. The condition analyzer 122 can estimate conditions of the product based on the product characteristics or attributes for the product. In some embodiments, the product characteristics are based in part on the feedback on the received attributes for the product or service. The condition analyzer 122 can modify the image of the product or update the characteristics based on the attributes received and estimated conditions. The condition analyzer 122 can generate corrections of the product data (image, characteristics, etc.) based on the estimated conditions.

In some embodiments, the condition analyzer 122 can receive product characteristics based in part on feedback on the received attributes of the product or service. The condition analyzer 122 can automatically diagnose product or service faults based on visual input or images of the product or service and product characteristics. The condition analyzer 122 can modify one or more images of the product or service (e.g. for generating an updated visualization of the product or service). The condition analyzer 122 can update product characteristics based on the attributes for the product or service. The condition analyzer 122 can provide feedback on the product or service based in part on the attributes and the diagnosed product or service faults.

Market analyzer 124 can analyze the market. In some embodiments, market analyzer 124 is configured to scrape data from third-party marketplaces or other sources with pricing information (e.g., manufacturer pricing) to store information to be used in estimating prices. Market analyzer 124 may store any information retrieved in price database 118. In some embodiments, market analyzer 124 may use parsing and matching techniques that including Scikit-Learn TFIDF Character 3-grams, Jaro Winkler distance metric and TheFuzz Levenshtein distance algorithms to match data across different data sources, validate, and parse effectively.

In some embodiments market analyzer 124 may be configured to analyze market information and, for example, store insights gathered in price database 118 for future use. For example, market analyzer 124 may be capable of sensing trends in certain types of products or services (e.g., popular vehicle models), and can store the trend insights in price database 118 for future use by price estimator 120.

In some embodiments, market analyzer 124 may use underlying raw data from the volume of products being bought and sold on platform 102 to predict market trends and pricing. In some embodiments, the underlying raw data may add multiple dimensions to market data and generate insights that predict, among other things, pricing trends, market and consumer demand, price prescription to buyers and sellers, just-in-time pricing.

Smart contract generator 126 can generate smart contracts. In some embodiments of platform 102, exchanges and/or transactions are finalized by way of smart contract (though in other embodiments, other finalizations can be used, such as conventional contracts). Smart contract generator 126 may be used in embodiments that have less trust between intermediaries. Smart contracts may, for example, be implemented through blockchain.

In some embodiments, users may be identified by their public key on a blockchain associated with the platform 102. In the context of a transaction, the seller may use smart contracts to define the terms of the sale by signing with their private key. The product would have its own blockchain address and public key that can be locked with a smart contract controlled smart lock once the buyer signs the smart contract using their private key and transfers the funds. This sold product may be delivered by the seller to the buyer's location or picked up by the buyer by unlocking the smart lock using their private key once the smart network verifies the ownership and payment by the seller. The smart contract can be immutable and available forever on the network.

In some embodiments, once the smart contract is executed, all subsequent transactions and ownership related information (e.g., in the case of a vehicle, vehicle maintenance, registration and damage records) may be added to the product's blockchain address.

The platform 102 may generate and manage a database of transactions and ownership related information for different products. The platform can use blockchain technology to create a secure and transparent record of an item's ownership, service history, and other important information. For example, the item may be a car, and securely capturing this data would make it easier for buyers to verify a car's history and avoid buying a vehicle with a hidden past.

Auction/transaction conductor 128 can conduct auctions or sales. Auction/transaction conductor 128 may enable buyers to, for example, place bids on or purchase products and services listed in the auction or listed for sale. Auction/transaction conductor 128 may enable buyers and dealers to search through the products and services offered for sale or auction. Auction/transaction conductor 128 may be configured to receive bids or offers from buyers and dealers and communicate these bids or offers to the sellers.

In some embodiments, auction/transaction conductor 128 may be configured to determine whether a bid or offer meets or exceeds a predefined buyout price and if so, may immediately transfer the rights to the products or services to the buyer in exchange for the buyout price (or the higher price). In some embodiments, auction/transaction conductor 128 may be configured to receive a plurality of bids or offers for an item, communicate these bids or offers to the seller, receive a counteroffer from the seller and communicate this counteroffer to the highest bidder or offeror. Auction/transaction conductor 128 may further be configured to immediately pass the counteroffer to the next highest bidder or offeror should the highest bidder or offeror reject the counteroffer.

In some embodiments, auction/transaction conductor 128 may facilitate the exchange of items between buyers, sellers, and dealers. For example, a user may seek to exchange one product (e.g., a vehicle) for another product (e.g., a boat). The user may list both their product and the product they are requesting in exchange. This user may seek a dealer to coordinate the requested exchange for the user in exchange for a commission. The auction/transaction conductor 128 may make these exchange transactions available to dealers through separate menus within platform 102.

In some embodiments, auction/transaction conductor 128 may provide a virtual dealership in the cloud. In some embodiments, the virtual dealership in the cloud may be a car or vehicle dealership. The virtual dealership may also relate to other products and services in various embodiments, such as boats, motor sport vehicles, and so on. The virtual dealership in the cloud may involve using cloud-based technologies to manage the sales and operations of a dealership. For example, auction/transaction conductor 128 can manage and store a dealership's inventory, customer information, sales data, and other important information in memory 108 (e.g. cloud storage). This virtual dealership may not own any inventory but may use other physical dealers' inventory to enable buy, sell and trade transactions online and manage other critical dealer functions like finance, warranty, insurance and service enablement and fulfillment digitally.

In some embodiments, auction/transaction conductor 128 may provide an interface to other dealer systems. The auction/transaction conductor 128 may receive input data feeds of products (e.g. cars, boats) and services available in their inventory. The auction/transaction conductor 128 may ingest the data feeds and normalize the data (including translating to user use cases). The auction/transaction conductor 128 provides dealership facilities such as, pickup, service, visualization of different attributes, (VR look of product), financing, warranties, managing life cycle of the product ownership. The auction/transaction conductor 128 manages these facilities directly. The platform 102 collects, normalizes and stores data for the product or service from the data feeds in the memory.

In some embodiments, auction/transaction conductor 128 may provide a subscription service. For example, the subscription service may be a car subscription service. In addition to buying and selling products, the platform 102 could offer a subscription service that allows users to rent products on a short-term basis to provide a sharing service with flexibility and choice. Users can choose from a variety of product types (e.g. vehicle makes and models), and can pay a monthly subscription fee that covers product related costs such insurance, maintenance, and other operating expenses related to the product. In some embodiments, auction/transaction conductor 128 may provide a subscription service using a cloud dealership implemented using distribution storage devices. The service can provide short term rental. The cloud platform 128 can provide interfaces for dealerships to offer their products (e.g. vehicles). In some embodiments, users can submit products for other users to rent.

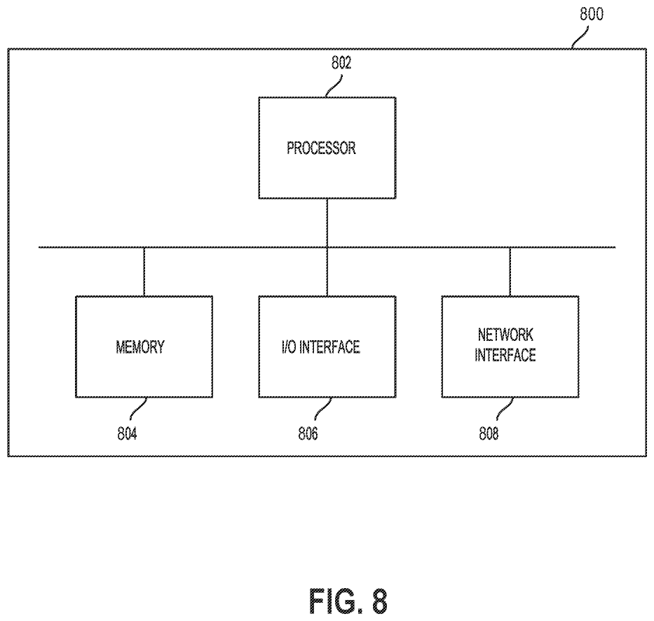

Terminals 104 can include the terminals that permit users (e.g., buyers, sellers, or dealers) to access platform 102. Terminals 104 may be technically the same as one another, but modify the user's access depending on that user's profile type (e.g., buyer, seller, or dealer). In some embodiments, terminals 104 may continually update a user feed permitting the user to see new products based on previous searches that they may be interested in seeing. In such embodiments, the feed may be (essentially) endlessly scrollable. In some embodiments, terminals 104 may be specialized units that may control access to platform 102. Terminals 104 can include seller terminals 130, dealer terminals 132, and buyer terminals 134. In some embodiments, terminals 104 comprise computing devices such as those described with reference to FIG. 8.

Seller terminals 130 can be interfaced with by a user to enable that user to list products or services for sale or auction on platform 102. Buyer terminals 134 can be interfaced with by a user to enable that user to purchase, or make an offer, or bid on products or services from platform 102. Trader terminals (not shown) can be interfaced with by a user to enable that user to, for example, list a product in the marketplace (for sale or auction) in exchange for another specific product (e.g., trade a boat for a vehicle). Dealer terminals 132 can be interfaced with by a user to buy and sell products for profit. Dealer terminals 132 can be conceived of as an intermediary in the marketplace process to, for example, buy and hold product when no buyers exist, to sell it later at a markup.

External widgets 106 are capable of extending the functionality of platform 102 by enabling platform 102 to interface with third-party infrastructure. A non-exhaustive list of example external widgets 106 can include dealer integration 136, insurance quote & sell widget 138, manufacturer integration 140, finance and lease widget 142, AR/VR integration 144, transport assist 146, GPS 148, and voice recognition 150.

Dealer integration 136 can integrate dealer systems with platform 102 through, for example, APIs. For example, dealer integration 136 can communicate with a dealer's system and automatically generate product information ready to list in an auction or sale. In some embodiments, dealer integration 136 may be configured to automatically put dealer inventory on sale or auction once entered into the dealer system (dealer inventory uploads). A dealer can customize the settings of dealer integration 136, such as by setting automatic minimum bids or offers, buyout prices, or other sale details.

In some embodiments wherein platform 102, makes vehicles available for purchase, dealer integration 136 may enable VIN decoding, option listings, and Vehicle History Report integration. VIN decoding may help identify the exact configuration including high-value features, custom features that were as ordered from the factory for that unique vehicle. In some embodiments, platform 102 may use decoded VIN information to provide accurate feature sets for the listed vehicles to generate accurate description and presentations of the vehicle to the prospective buyer (e.g., the VIN information may be used to update the AR/VR visualizations). Vehicle History Report integration may help platform 102 decode up-to-date vehicle data including ownership, damages, insurance claims, and other vital details to provide accurate information for that exact vehicle.

Insurance quote & sell widget 138 can be configured to provide insurance or warranty quotes and execute insurance contracts for products or services purchased. The term insurance as used herein can also include warranties. In some embodiments, after successful purchase of a product or service, platform 102 may take the buyer information (if necessary for insurance or warranty quote) and the product or service information and generate an insurance quote through a third-party insurance provider. In some embodiments, the buyer will further be able to purchase the insurance for the quoted price without the need for redirection to the insurance website. In some embodiments, the Insurance quote & sell widget 138 may only provide an estimate and prompt the user to enter additional information (e.g., should it have been missing from the buyer profile) to generate an insurance quote. In some embodiments the Insurance quote & sell widget 138 can also provide warranties to the user.

Manufacturer integration 140 can integrate a manufacturer's infrastructure with platform 102 through, for example, APIs. Like dealer integration 136, manufacturer integration 140 can be used to automatically generate new auction or sale listings based on manufacturer inventory, and can automatically initiate the auction or sale of manufacturer inventory. A manufacturer can customize the settings of the manufacturer integration 140 such as by setting automatic minimum bids or offers, buyout prices, or other sale details. Like dealer integration 136, manufacturer integration 140 can automatically generate product information ready to list in an auction or sale. Manufacturer integration 140 can also allow users to customize an order by selecting different product features directly from platform 102 without the need for redirection to the manufacturer's website.

In some embodiments, manufacturer integration 140 may enable users to shop by manufacturer. On some vehicle manufacturer websites a user can build a custom vehicle configuration and receive a “build it now” code from the manufacturer's site. Platform 102 may be integrated with the manufacturer's site such that the user can lookup and buy the configured vehicle using this code. In some embodiments, platform 102 may connect to the manufacturer's systems using manufacturer integration 140 to access the vehicle configuration using the “build it now” code, retrieve the configuration, and make it available for purchase from platform 102. Users can also use this configuration to look for similar new and used vehicles that match the configuration on platform 102. In some embodiments, when users enter the “build it now” code into the platform 102, they may be directed to the nearest vehicle to them with their set of defined specifications from manufacturer's build code. Entering the code may also display similarly equipped vehicles across manufacturers, complete with vehicle ratings, explain price differences and cost of options to highlight vehicle equipment differences from desired build code, or one vehicle to another. In some embodiments, the user may copy a code from the manufacturer's website and paste it into terminals 104 and platform 102 will use the user's profile to populate information and simplify ordering a new product.

Finance and lease widget 142 can provide financing options to buyers and prospective buyers. In some embodiments, platform 102 may provide an option to explore financing available to any buyers while they look for products and services to buy and/or bid on. The finance and lease widget 142 may retrieve information from the user's profile or prompt the user to enter information to determine that user's financing and lease options. Finance and lease widget 142 may be configured to enable financing and leasing through the widget without directing the user away from platform 102.

In some embodiments, finance and lease widget 142 can interoperate with platform 102 to enable a user to coordinate financing in light of a bid or offer and automatically cancel the financing if the buyer's bid or offer is unsuccessful. In some embodiments, finance and lease widget 142 can coordinate leasing or financing for a type of product or service and, should the buyer be unable to successfully identify a product or service of that type within, for example, a certain timeframe, automatically cancel the lease or financing agreement. In some embodiments, the finance and lease widget 142 can provide financing and leasing to the buyer conditional on the buyer finding a suitable product or service to buy. In some embodiment, the finance and lease widget 142 may activate when user activity indicates that the buyer is interested in a particular product or service, but does not seem able to buy it (e.g., where the user returns to a product well above the cost of most other types of that product they are reviewing).

AR/VR integration 144 can integrate platform 102 with augmented reality and virtual reality (AR/VR) content. AR/VR integration 144 can be used to enable sellers to upload content into platform 102 and have that content assembled into an AR/VR format. In some embodiments, AR/VR integration 144 can be used to generate standardized AR/VR content (e.g., to enable a prospective buyer to inspect the make/model of a vehicle prior to placing a bid or offer). In some embodiments, AR/VR integration can take, for example, product information and generate AR/VR content by modifying standard AR/VR content with the product information (e.g., if the product is a Aston Martin Vulcan known to have a dent in the passenger-side door, then the AR/VR model generated will be one of a standard Aston Martin Vulcan modified to include a dent in the passenger-side door). AR/VR integration 144 may also enable buyers and dealers to inspect the products or services in AR/VR prior to placing an offer or bid by enabling interoperation with AR/VR hardware. In some embodiments, a VR test drive may be generated using the relevant vehicle on a pre-set “test drive route”.

In some embodiments, AR/VR integration can enable the use of AR/VR glasses hardware. In such embodiments, buyers can observe product (e.g., vehicle) details, photos, videos, 360 degree experiences including audio using VR/AR glasses while using platform 102. Sellers can use VR/AR glasses to capture and record audio and video while walking-around (or, in the case of vehicles, moving through the interiors) to create audio-video content that may then be uploaded to their product's listing for sale.

Transport assist 146 can assist with transport. In some embodiments, where a user has successfully sold their vehicle, transport assist 146 can coordinate with third-party driving services (e.g., taxis, or ride-share programs) to facilitate a ride for the user once they have given up their vehicle. In some embodiments, transport assist 146 can also enable border free title assistance across markets. In some embodiments, where the buyer and seller are in different locations, transport assist 146 can support the transport of the product between the users.

GPS 148 can provide location-based services. For example, a user may be interested in searching for specific products and services within a certain distance of their current location. GPS 148 can feed data into the search functions of platform 102 to narrow the search to products and services in close proximity to the user. In some embodiments, platform 102 may (provided the user has granted access to GPS data) preferentially sort product and service searches by proximity. In some embodiments, the system 100 may permit a user to search for products and services in specific locations (e.g., if the user knows they will be travelling to Europe from the US in a week's time they may search for listings based in Europe).

Voice recognition 150 can recognize user voices. In some embodiments this can be used to provide voice-based access to vehicle inventory. In some embodiments, system 100 can use Smart Assistants to read out vehicles available and express interest to book a test drive or to get more information sent asynchronously via other digital channels.

The platform 102 can receive attributes for a product or service from the seller terminal 130, and also from the product database 114. The hardware processor 110 can process the attributes for the product or service by engaging the condition analyzer 122. The hardware processor 110 can generate pricing data for the product or service using the price estimator 120 and the market analyser 124. The platform 102 facilitates a product or service listing by providing an communication interface between the seller terminal 130, and the buyer terminal 134 using the auction/transaction conductor 128 to list the product or service, receive a plurality of bids or offers, assess bids or offers, and determine whether there is an accepted bid or offer. In some embodiments, the platform 102 facilitates a product or service listing by providing an communication interface between the seller terminal 130, and the buyer terminal 134 and at least one of the dealer terminal 132. Each of the seller terminal 130, the dealer terminal 132, and the buyer terminal 134 can have a memory and a hardware processor to execute instructions for an interface that can display visualizations of the product or service, or data relating to bids or offers. The platform 102 can dynamically update the interfaces to provide visualizations of the product or service based on the attributes. The platform 102 can generate a smart contract for the product or service using the smart contract generator 126 in response to receiving confirmation from the seller terminal for the accepted bid or offer. The smart contract can be a computer program or transaction protocol to automatically record, execute, enforce, or control events or actions according to the terms of purchase and sale of the product or service. The platform 102 transmits the smart contract code using the interface. The platform 102 collects, normalizes and stores data for the product or service, the attributes, and the pricing data in the memory.

In accordance with an aspect, there is provided system 100 for an online marketplace for goods and services. System 100 includes a non-transitory memory 108 storing instructions having an interface for a seller terminal 130, a dealer terminal 132, and a buyer terminal 134, and a hardware processor 110. Hardware processor 110 executes the instructions to receive attributes for a product or service from the seller terminal, process the attributes for the product or service using condition analyzer 122, generate pricing data for the product or service using price estimator 120 and a market analyser 124, facilitate a product or service listing using the interface between the seller terminal 130 and at least one of the dealer terminal 132, and the buyer terminal 134 using auction/transaction conductor 128 to list the product or service, receive a plurality of bids or offers, assess bids or offers, and determine whether there is an accepted bid or offer, update the interface to provide visualizations of the product or service based on the attributes, and generate a smart contract for the product or service using the smart contract generator 126 in response to receiving confirmation from the seller terminal for the accepted bid or offer.

In accordance with a further aspect, the visualizations of the product or service are provided by the hardware processor 110 at an interface in an augmented or virtual reality format.

In accordance with a further aspect, the pricing data for the product or service is based in part on the feedback on the product or service. Hardware processor 110 can use the feedback data to generate pricing data.

In accordance with a further aspect, system 100 further includes insurance or warranty quote and sale provider 138 to accept information on a buyer and on the attributes for the product or service to facilitate the quote and sale of insurance or warranty on the product or service to the buyer.

In accordance with a further aspect, system 100 further includes finance and lease provider 142 to accept information on a buyer and on the attributes for the product or service to facilitate the provision of financing options for the product or service to the buyer.

In accordance with another aspect, there is provided system 100 for an online marketplace for goods and services. System 100 includes non-transitory memory 108 storing instructions having an interface for seller terminal 130, dealer terminal 132, and buyer terminal 134, and hardware processor 110. Hardware processor 110 executes the instructions to receive attributes for a product or service from the seller terminal 130, process the attributes for the product or service using condition analyzer 122, generate pricing data for the product or service using price estimator 120 and market analyser 124, facilitate a product or service listing using the interface between seller terminal 130 and at least one of the dealer terminal 132, and buyer terminal 134 using auction/transaction conductor 128 to list the product or service, receive a plurality of bids or offers, assess bids or offers, and determine whether there is an accepted bid or offer, and update the interface to provide visualizations of the product or service in an augmented or virtual reality format based on the attributes.

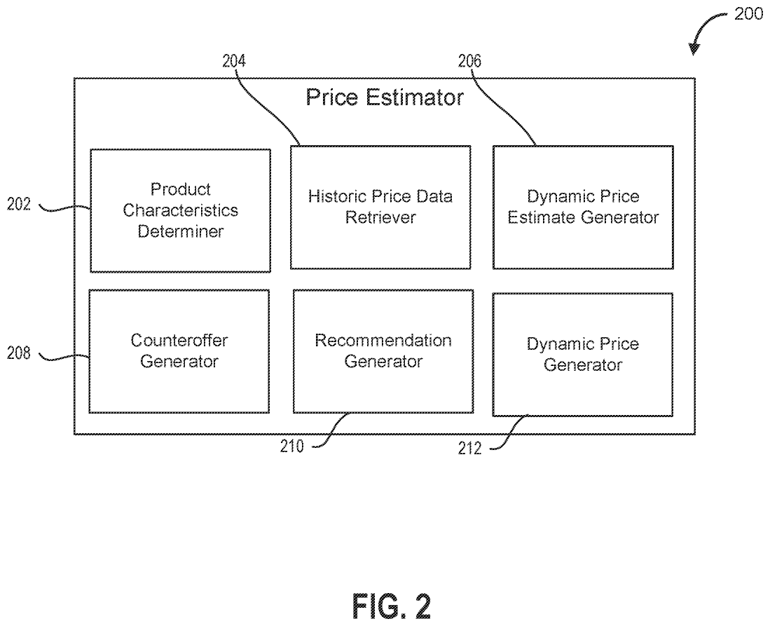

FIG. 2 illustrates an example of a price estimator, according to some embodiments.

Price estimator 200 illustrates the workings of price estimator 120 according to some embodiments. Price estimator 200 includes product characteristics determiner 202, historic price data retriever 204, dynamic price estimate generator 206, counteroffer generator 208, recommendation generator 210, and dynamic price generator 212.

Product characteristics determiner 202 can retrieve and determine the product (or service) characteristics. Product characteristics determiner 202 can take the product or service characteristics (e.g., a vehicle's make model, mileage, fault issues, etc.) as entered by the user and/or as determined by smart fault detection (e.g., through condition analyzer 122). Product characteristic determiner 202 may then pass this information to other parts of price estimator 200.

Historic price data retriever 204 retrieves a historic price of the product or service. Historic price data retriever 204 can use the product or service characteristics to pull relevant historic price data of the same or similar condition products. In some embodiments, the user may enter similarity criteria to assist historic price data retriever 204 to understand the factors that are driving the buyer's behaviour. In some embodiments, historic price data retriever 204 may use AI to filter/weight all historic data.

Dynamic price estimate generator 206 generates a price estimate. Dynamic price estimate generator 206 can take the product or service characteristics and the historic price data to algorithmically determine the price for the product or service. In some embodiments, dynamic price estimate generator 206 may take other external factors into account (e.g., rarity of item, current trends, in the case of counteroffers, counterparty characteristics, etc.). In some embodiments, dynamic price estimate generator 206 generates price estimates based in part on machine learning. In some embodiments, dynamic price estimate generator 206 generates prices based on actual data compiled from vehicle makes/models searched, sales, and availability in the market.

Counteroffer generator 208 generates counteroffers. In some embodiments, the seller can put products or services up for sale or on auction. In these circumstances they may be able to receive a plurality of bids or offers. Rather than accepting the highest bid or offer, the seller may be able to make a counteroffer to the highest bidder or offeror (or otherwise the most preferred bidder or offeror). Counteroffer generator 208 can use historic price data, product characteristics, and/or user preferences to generate a counteroffer. In some embodiments, counteroffer generator 208 may be configured to automatically make certain counteroffers available or visible to all bids/offers or to bids/offers matching certain criteria. In further embodiments, the automatic counteroffer may vary as a function of auction or sale duration. In some embodiments, counteroffer generator 208 generates counteroffers based in part on machine learning.

Recommendation generator 210 can generate recommendations. Recommendation generator 210 can assess incoming bids or offers and provide the seller with a recommendation or assessment of the bid or offer. In some embodiments, recommendation generator 208 can take external factors into account (e.g., seller's eagerness to sell, interest in seeking best price, etc.). In some embodiments, recommendation generator 210 makes use of machine learning to provide helpful recommendations. In some embodiments, recommendation generator 210 makes recommendations based on information in the user profile or in past user behaviour.

In some embodiments, recommendation generator 210 can have a machine learning recommendation engine. This engine can use machine learning to analyze user data and provide personalized recommendations for cars that match their preferences, budget, and other criteria. Recommendation generator 210 could also use predictive analytics to suggest cars that are likely to hold their value or be in demand in the future.

Dynamic price generator 212 generates prices based on actual data compiled from vehicle makes/models searched, sales, and availability in the market.

In accordance with a further aspect, price estimator 200 includes product characteristics determiner 202 to determine the product or service characteristics based in part on the attributes for the product or service, historic price data retriever 204 to retrieve historic price data of products or service with similar characteristics to the product or service characteristics, and dynamic price generator 206 to dynamically generate a price based in part on the product or service characteristics and the historic price data.

In accordance with a further aspect, price estimator 200 further includes recommendation generator 210, and the assess bids or offers provides recommendations on acceptance of a bid or offer based on the attributes for the product or service using the recommendation generator.

In accordance with a further aspect, price estimator 200 includes counteroffer generator 208 to generate counteroffers to bids or offers.

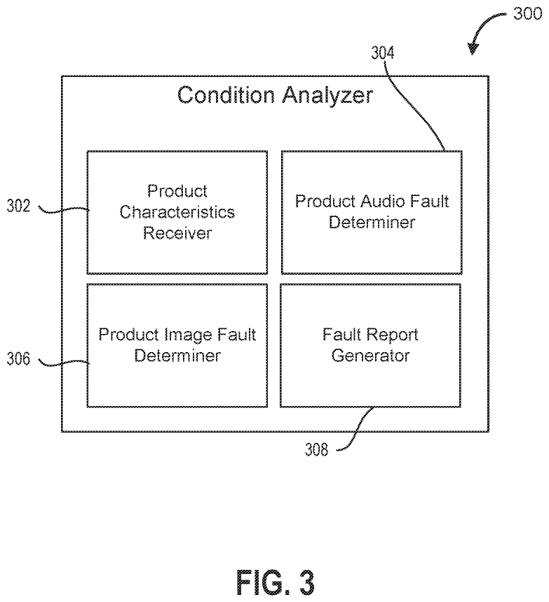

FIG. 3 illustrates an example condition analyzer, according to some embodiments.

Condition analyzer 300 illustrates the workings of condition analyzer 122 according to some embodiments. Condition analyzer 300 can include product characteristics receiver 302, product audio fault determiner 304, product image fault determiner 306, and fault report generator 308.

Product characteristic receiver 302 is configured to receive the product or service characteristics as entered by the user. These may be retrieved from, for example, product database 114. Product characteristics can include, for example, referring to a vehicle, the vehicle's year, make, model, mileage, trim, postal/zip code, etc.

Condition analyzer 300 generates a mapping between product or service characteristics (e.g. vehicle specification data) and customer use case data. Product characteristic receiver 302 can receive the product or service characteristics can convert the data to customer user data, and vice versa. Condition analyzer 300 uses the mapping to convert or translate product or service characteristics to customer use case data, or to convert or translate customer use case data to product or service characteristics. In some embodiments, condition analyzer 122 can have a machine learning model to process vehicle specification data, such as a model based on linear regression and/or decision trees, for example. Other types of machine learning models can also be used to process product or service characteristics. For example, condition analyzer 122 can be used to process input data to convert/translate to different parameters for customer use cases. The condition analyzer 122 uses the mapping to convert or translate product or service characteristics to customer use case data, or to convert or translate customer use case data to product or service characteristics.

This may involve machine learning from base data models that ingest multiple product specification data formats from multiple data vendors to build a baseline for several data points. This data can be mapped to real-world consumer friendly data interests and uses cases that consumers are interested in.

In some embodiments, condition analyzer 300 can implement a data mapping layer between specification data and consumer facing information. The condition analyzer 300 can be for loading data, translating data using machine learning to define what user data structures the car data can be mapped to (e.g. small dogs, bike). The condition analyzer 300 can convert the specification data to use cases by mapping product specification data to consumer facing data (user scenario variables).

Product audio fault determiner 304 can optionally determine faults through audio information. Product audio fault determiner 304 can receive audio recordings of the product performing certain functions and can determine whether there are faults. For example, if the product is a vehicle, product audio fault determiner 304 can listen to audio information from the product while its engine is idling to determine if there are certain forms of engine trouble. In some embodiments, product audio fault determiner 304 uses machine-trained models to identify faults. In some embodiments, for example those selling or auctioning vehicles, platform product audio fault determiner 304 can use machine-trained models capable of identifying the most common sounds from a running vehicle. These include sounds from the engine bay, including motor sounds, belt noise, throttle and others to determine the mechanical condition of the vehicle including potential flaws and maintenance problems. In further embodiments, product audio fault determiner 304 can make use of buyer reviews of past products to update its training. In some embodiments, this can be an optional feature sellers can make use of to bolster their product or service's profile on platform 102.

Product image fault determiner 306 can optionally determine faults through visual information. Product image fault determiner 306 can receive images of the product or service and determine whether there are faults. For example, if the product is a ring, product image fault determiner 304 can analyze the images to ascertain any clarity issues the ring may have or other imperfections. In some embodiments, it may be capable of generating a 3D model of the product to ascertain whether there are faults. In some embodiments, product image fault determiner 306 compares provided images against standard images to determine visual faults. In some embodiments, product image fault determiner 306 can dynamically assess the product for faults by algorithmically predicting what the product should look like and identifying any differences. In some embodiments, for example those selling or auctioning vehicles, product image fault determiner 306 uses machine learning to identify faults. In some embodiments, product image fault determiner 306 can use visual images, videos high-to-low resolution, and across varying light and weather conditions to learn variations and anomalies from a baseline standard for one or more vehicles of differing years, makes, models, and trims. All variations are derived from a single deep learning model to detect surface damage, color imperfections, glass condition, tire tread and depth, make, model and year, color and more. In further embodiments, product image fault determiner 306 can make use of buyer reviews of past products to update its training. In some embodiments, this can be an optional feature sellers can make use of to bolster their product or service's profile on platform 102. In some embodiments, the images can comprise video information.

Fault report generator 308 can generate fault reports for use in platform 102. Fault report generator 308 can take information generated from one or more of product characteristic receiver 302, product audio fault determiner 304, and product image fault determiner 306 and generate a fault report. This fault report can either be associated with the product or service in the product database 114 and made available to prospective buyers or it can be further analyzed by price estimator 120 to provide more accurate price estimates.

In accordance with a further aspect, condition analyzer 300 includes product characteristics receiver 302 to receive the attributes for the product or service, product image fault determiner 306 to diagnose product or service faults based on visual input of the product or service, and fault report generator 308 to provide feedback on the product or service based in part on the attributes and the diagnosed product or service faults.

In accordance with a further aspect, condition analyzer 300 further includes product audio determiner 304 to diagnose product or service faults based on audio input of the product or service.

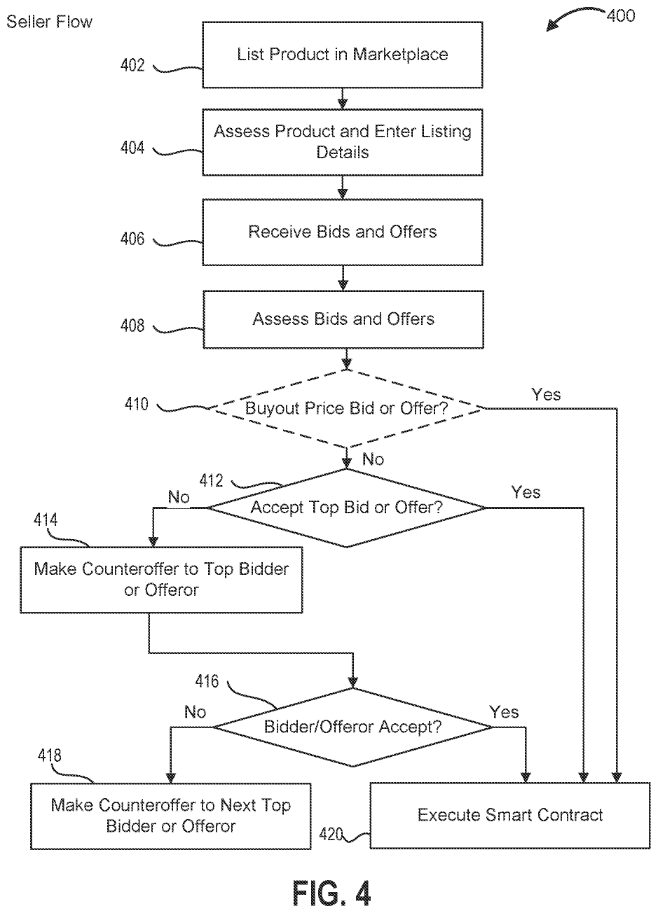

FIG. 4 illustrates an example process diagram for listing a product in the online marketplace, according to some embodiments.

Process 400 provides an example process of a seller listing an item (or service) in a marketplace and having a buyer buy it. Process 400 includes the seller listing their product in the marketplace (402), the seller assessing the product and entering listing details such as minimum offer or bid (404), the seller receiving a plurality of bids or offers from prospective buyers (406), and the seller assessing those bids or offers (408). In some embodiments, process 400 may include a buyout price and bids or offers will be compared to the buyout price (410). If the bid or offer meets (or even exceeds) the buyout price, the seller will automatically accept that bid/offer and the bidder/offeror (i.e., the buyer) and seller will automatically agree to the transaction (possibly by executing a smart contract) (420). In some embodiments, process 400 will ask the seller if they accept any of the bids or offers (likely the top bid/offer) (412). If the seller accepts the bid/offer, the bidder/offeror and seller will agree to the transaction (possibly by executing a smart contract) (420). If the seller does not accept the bid, then they may make a counteroffer (414). The bidder/offeror can then choose to accept the counteroffer (416). If the bidder/offeror accepts the counteroffer, then the bidder/offeror and seller agree to the transaction (possibly by executing a smart contract) (420). If the bidder/offeror does not accept the counteroffer, then the seller may then make the counteroffer to another bidder (likely the next top bidder/offeror) (418). In some embodiments there may be multiple rounds of offer and counteroffer with the same seller and bidder/offeror. The platform 102 transmits the smart contract code using the interface. The platform 102 collects, normalizes and stores data for the product or service, the attributes, and the pricing data in the memory.

In some embodiments, the seller is capable of providing input into platform 102 which will then be used to generate AR/VR simulations of the product or service. The seller may be able to provide this input at, for example, entry of their product or service's information into platform 102, listing of their product or service in the marketplace (i.e., step 402), as part of their product or service's assessment (404), or other times as appropriate. These AR/VR simulations may also be used to assess the condition of the product or service. In some embodiments, VR walk-throughs of the product or service may be generated to enable potential buyers to see the product. In some embodiments, the seller may construct a VR test drive. In such embodiments, the VR test drives could be constructed from using the relevant vehicle on a pre-set “test drive route” that may provide the basis of every “VR test drive” enabling the experience with different vehicles (or other products) to be compared.

In some embodiments, the product assessment of step 404 can be conducted using the price estimator 120. The price estimator 120 can take all available information regarding the product or service and generate an estimate and other optimal listing details. The seller may then use that estimate or ignore it. In some embodiments, the seller may configure the system to automatically list their product (or service) at price estimator 120's recommendations. Dealer integration 136 or manufacturer integration 140 can make use of price estimate 120 to automatically and dynamically list products (or services) in this way. In some embodiments, automatic product listing can further be implemented using machine learning.

In some embodiments, the bid or offer assessment of step 408 can be assisted with the price estimator 120 (e.g., recommendation generator 210). For example, when the seller receives the bids/offers, platform 102 can sort the bids/offers from highest to lowest to provide a relative analysis and price estimator 120 can provide feedback on the quality of the top bid or offer relative to the market. In some embodiments, the seller may be asking for another product or service in exchange. In these embodiments, price estimator 120 can analyze the products included in the bid or offer for exchange to more objectively rate them as compared to each other (especially where the bids or offers include a monetary and product offerings).

In some embodiments, the bid or offer assessment of 408 can automatically select a top bid or offer based on seller preferences. This would still differ from the buyout price of 410. The buyout price may be visible to the bidders and offerors whereas the automatic bid or offer assessment and acceptance may only occur after the auction or sale has reached a certain duration, number of bids/offers, or other such criteria. The automatic bid or offer acceptance can be implemented using machine learning.

In some embodiments, price estimator 120 can provide a counteroffer recommendation using, for example, counteroffer generator 208. In these embodiments, counteroffer generator 208 may take the product factors into account. In further embodiments, counteroffer generator 208 may take bidder/offeror specific characteristics into account (e.g., how likely would they be to accept an offer that represents a 20% increase of their bid or offer). Counteroffer generator 208 may make counteroffers automatically depending on seller preferences and other factors. This automatic counteroffer can be based on machine learning.

Though process 400 has been generally described as a conventional auction or sale, process 400 can also be adapted to receive bids or offers that include a product or service for exchange in addition to or instead of a monetary bid or offer.

In accordance with another aspect, there is provided method 400 for an online marketplace. The method includes receiving attributes for a product or service (402), processing the attributes for the product or service using a hardware processor, generating pricing data for the product or service using the hardware processing (404), facilitating a product or service listing using an interface between a seller terminal and at least one of a dealer terminal and a buyer terminal using an auction/transaction conductor to list the product or service, receive a plurality of bids or offers (406), assess bids or offers (408), and determine whether there is an accepted bid or offer (412), updating the interface to provide visualizations of the product or service based on the attributes, and generating a smart contract for the product or service in response to receiving confirmation from the seller terminal for the accepted bid or offer (420).

In accordance with a further aspect, the generating pricing data (404) further includes determining the product or service characteristics based in part on the attributes for the product or service, retrieving historic price data of products or service with similar characteristics to the product or service characteristics, and dynamically generating a price based in part on the product or service characteristics and the historic price data.

In accordance with a further aspect, the assess bids or offers (406) includes providing recommendations on acceptance of a bid or offer based on the attributes for the product or service.

In accordance with a further aspect, the method further includes generating counteroffers to bids or offers (414).

In accordance with a further aspect, the visualizations of the product or service are provided in an augmented or virtual reality format.

In accordance with a further aspect, the generating pricing data (404) includes receiving the attributes for the product or service, diagnosing product or service faults based on visual input of the product or service, and providing feedback on the product or service based in part on the attributes and the diagnosed product or service faults.

In accordance with a further aspect, the generating pricing data (404) further includes diagnosing product or service faults based on audio input of the product or service.

In accordance with a further aspect, the pricing data is based in part on the feedback on the product or service.

In accordance with a further aspect, the method further includes accepting information on a buyer, and facilitating the quote and sale of insurance on the product or service to the buyer.

In accordance with a further aspect, the method further includes accepting information on a buyer, and facilitating the provision of financing options for the product or service to the buyer.

In accordance with another aspect, there is provided a method for an online marketplace. The method includes receiving attributes for a product or service (402), processing the attributes for the product or service using a hardware processor, generating pricing data for the product or service using the hardware processing (404), facilitating a product or service listing using an interface between a seller terminal and at least one of a dealer terminal and a buyer terminal using an auction/transaction conductor to list the product or service, receive a plurality of bids or offers (406), assess bids or offers (408), and determine whether there is an accepted bid or offer (412), and updating the interface to provide visualizations of the product or service in an augmented or virtual reality format based on the attributes.

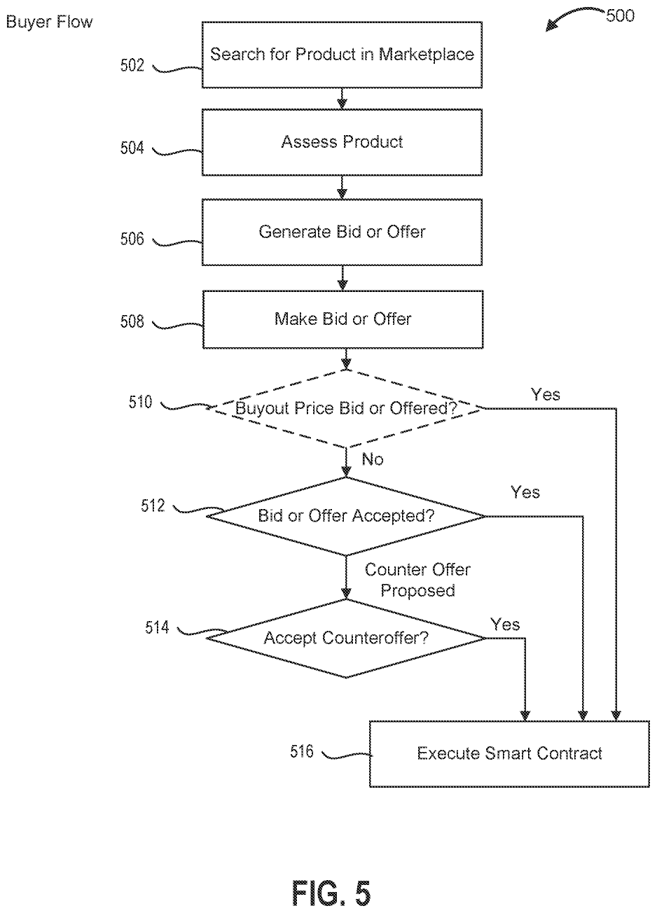

FIG. 5 illustrates an example process diagram for purchasing a product in the online marketplace, according to some embodiments.

Process 500 provides an example process of a buyer searching for a product (or service) in a marketplace and attempting to buy it. The buyer first searches for a product (or service) in the marketplace (502). On finding a specific listing of interest, the buyer assesses the product based on the information available (504) and may optionally generate a bid or offer suggestion using price estimator 120 (506). The buyer is then able to enter a bid or offer on the product (508). In some embodiments, there may be a buyout price (possibly visible to the buyer) and if the buyer's bid/offer meets or exceeds this buyout price (510), the purchase will automatically proceed (possibly by executing a smart contract) (516). In some embodiments, the seller will consider the bid or offer (512). If the seller accepts the bid/offer, then the purchase will automatically proceed (possibly by executing a smart contract) (516). If the seller does not accept the bid/offer, then the seller may make a counteroffer at which point the buyer can consider the counteroffer (514). If the buyer accepts the counteroffer then the purchase will proceed (possibly by executing a smart contract) (516). If the buyer does not accept, then the buyer can continue searching the product database for another possible product. In some embodiments, Platform 102 allows the buyer to repeat the process and make another counteroffer.

In some embodiments, the product assessment of 504 can be assisted by price estimator 120. In these embodiments, the price estimator 120 can take all available information on the listed product into account (including, for example, age, and known faults) and generate an assessment of the price fairness. In some embodiments, the buyer may inspect the product or services using AR/VR implementations (e.g., AR/VR inspection, VR test drive, etc.).

In some embodiments, the price estimator 120 can assist the buyer in generating a bid or offer (506). In these embodiments, the price estimator 120 can take all available information on the listed product into account (including, for example, age, and known faults) and generate a proposed bid or offer for the buyer to consider using. In some embodiments, the price estimator 120 can be configured to automatically make bids or offers based on buyer preferences. Such implementations may be attractive to dealers who are buying and selling a higher volume of products or services. In some embodiments, the buyer's bid or offer may include a service or product in addition or instead of a monetary bid or offer.

In some embodiments, the price estimator 120 can provide guidance on whether the counteroffer is reasonable at step 514. In some embodiments, the price estimator can be configured to automatically accept or reject counteroffers based on buyer preferences (and other factors). In some embodiments, automatic counteroffer acceptance is implemented using machine learning.

Though process 500 has been generally described as a conventional auction or sale, process 500 can also be adapted to receive bids or offers that include a product or service for exchange in addition to or instead of a monetary bid or offer.

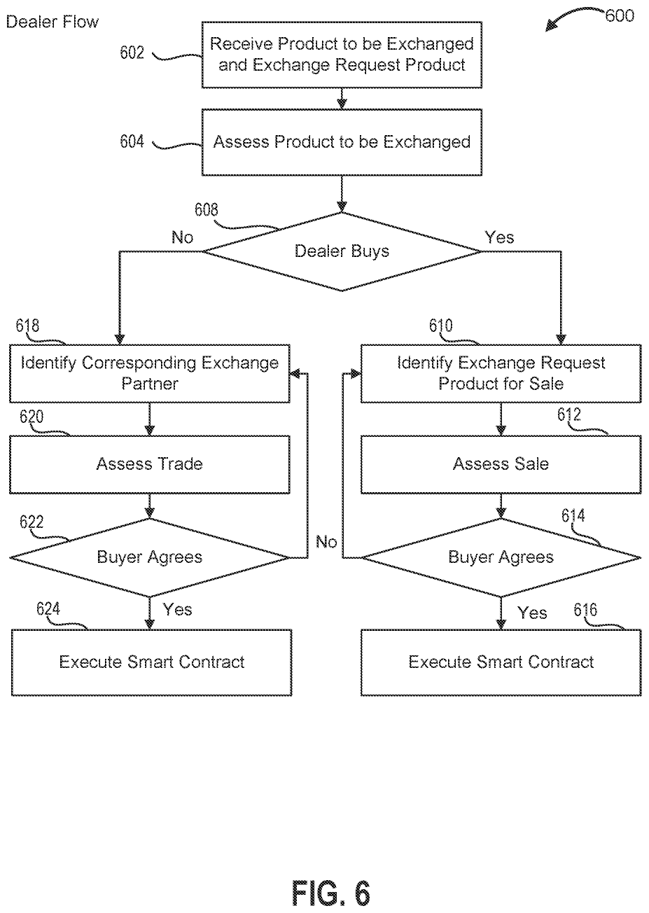

FIG. 6 illustrates an example process diagram for coordinating an exchange as a dealer, according to some embodiments.

Process 600 provides an example process of a dealer enabling a product and/or service exchange. In some embodiments of system 100, buyers and sellers can instead be conceived of as traders. In such embodiments some individuals are looking to purchase one product or service in exchange for another (and possibly money to cover any difference in value). In some embodiments, such sorts of listings could be segmented such that buyers who were not interested in exchange need not see the exchange requests.

In these embodiments, dealers may be enabled to coordinate the exchange between two interested parties. The dealer first receives or identifies a product to be exchanged (given up) and an exchange request product (received in return) from a “buyer” (602). The dealer can then assess the product to be exchanged (604). In some embodiments, the dealer may be given the option to purchase the product to be exchanged (608). In such embodiments, where the dealer elects to buy the product to be exchanged, they may provide credit for the product to be exchanged (either absolutely or conditionally). The dealer must then identify a suitable exchange request product (610), assess the sale (612), and see if the buyer agrees to purchase that product (614). If the buyer accepts then the sale is finalized, the dealer provides their credit (or other monetary arrangement) to the buyer and the buyer purchases the product from the seller (possibly by executing a smart contract) (616). If the buyer does not agree, then the dealer continues looking for a suitable exchange request product (610). Though steps 610-616 are abbreviated, it is to be understood that searching for a product may proceed by the same process as the process detailed in process 500 with the added detail that a dealer is facilitating and coordinating the searches. As such, there may be a buyout price or a counteroffer.

Where the dealer cannot or does not buy the product to be exchanged at 608, then the dealer will need to search for a suitable exchange (i.e., a counterparty looking to receive the buyer's product to be exchanged and to give up the buyer's exchange request) (618). The dealer then assesses the trade (620) and sees if the buyer will agree to the exchange (622). If the buyer accepts then the sale is finalized and the buyer and the seller exchange items and any negotiated monetary difference (possibly by executing a smart contract) (624). If the buyer does not agree, then the dealer continues looking for a suitable exchange (618). Though steps 618-624 are abbreviated, it is to be understood that searching for a product may proceed by the same process as the process detailed in process 500 with the added detail that a dealer is facilitating and coordinating the searches. As such, there may be a buyout price or a counteroffer.

In some embodiments, the dealer's assessment of the product at step 604 may be assisted and/or automatically decided by price estimator 120. In some embodiments, the dealer is able to assess the product using AR/VR implementations.

In some embodiments, while assessing the trade or sale at 612 and 620, the dealer and/or buyer can inspect the product or service via AR/VR functionality and use condition analyzer 122, and market analyzer 124.

In some embodiments, users can request trade process routes. Trade process routes can enable users to more favourably structure of product (e.g., vehicle) trade-in. In the context of vehicles, user may be unable to pre-sell their current vehicle to another user, and use that vehicle as a trade-in for favourable tax treatment. In some embodiments, platform 102 would automate the ability for a first user to presell a first vehicle to a second user, and trade that first vehicle in to a dealer as part of a second, new (or used) vehicle purchase from that dealer (who in turn sells the first vehicle to the second user). These embodiments may automate and complete the paperwork to ensure the first vehicle title is passed from the first user to the dealer and then to the second user from the dealer, ensure that the transaction from the first user receives favourable tax treatment with respect to value of the first vehicle, automate and complete the a paperwork to effectively sell the vehicle from the dealer to the second user. The dealer may also gain two opportunities to gain new customers. In some embodiments, system 100 enables the automation and secure and effective title transfer of a product to provide favourable tax treatment to one or more users using smart contracts.

Some embodiments are configured to preferentially sell one asset type (e.g., vehicles) while accepting trade-ins of other asset types to be credited towards the purchase of that one asset type. Any authentic physical asset that has a valid serial number may be acceptable as trade-ins subjected to their appraised value.

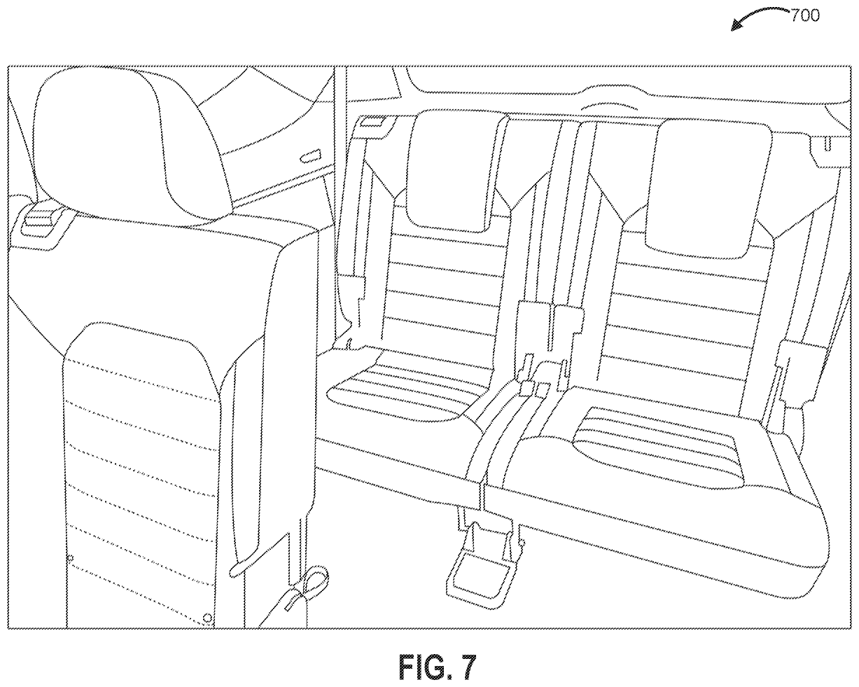

FIG. 7 illustrates an example instructional photo used to assist the seller in obtaining the requisite images to generate AR/VR content, according to some embodiments.

In some embodiments, the seller (or dealer as the case may be) is able to upload content including, but not limited to, photographs with guided layovers, 2D videos, 360 and 3D videos, and audio related to multiple angles of the product. For example, if the product is a vehicle the angles may include the vehicle's exterior, interior, above and below (undercarriage) as well as the engine/motor bay.

In some embodiments, the seller may require some combination of 3D and 360 Degree cameras, camera mobile apps, 360 and 3D module attachments to existing devices (phones, tablets and computers), and/or software to process and annotate these images and videos to obtain the necessary images to permit system 100 to generate AR/VR content of the product. The seller may be provided instructions to generate each photo or video. This can be done using image and video overlays in the camera's viewfinder. FIG. 7 illustrates an example instructional photo used to assist the seller in obtaining the requisite images to generate AR/VR content, according to some embodiments. For example, the image in FIG. 7 could be overlain on the seller's camera display to aid the seller in capturing a substantially similar image of their own vehicle. The image overlays may be generic structure suitable to most or all of the products in that category (e.g., a generic vehicle structure used to overlay any vehicle) or they may adapt to the specific subset of product the user is attempting to photograph (e.g., like in FIG. 7, presenting an overlay that is substantially similar to the make and model of the seller's product). The image overlays may help the seller frame the photo or video in order to capture the exact visual content recommended for their vehicle listing. The seller will be advised to stay within the boundaries of the overlay to capture the frame. System 100 may be configured to discard any visuals captured outside the frame to ensure uniformity and standardization.

In some embodiments, where the seller has taken several photos, system 100 can work to stitch the photos together in a manner that generates AR/VR content based on the product.

In some embodiments, where the seller has not obtained photos, video, etc. necessary for AR/VR content generation or where this is not enabled, there can be default photo/video placeholders. In some embodiments, the placeholders can map to the product characteristic (e.g., for a vehicle the default placeholders can adapt to the year, make, model and condition (including scrapes, dents and issues) of the seller's vehicle).

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the systems and methods described herein may offer more efficient online marketplaces for the purchase and sale of certain assets (such as vehicles). The implementation of smart contracts in the marketplace may, in some embodiments, reduce the need for trusted intermediaries. In some embodiments, the AR/VR content generation may enable users to more easily assess products remotely for purchase. In some embodiments, the intelligent price assessment and condition analyzer can further level the marketplace and enable trust in an online setting (where the user cannot inspect the product in person). Some systems provided herein may provide accurate value assessment by providing pre-inspection of products (e.g., vehicles) by owners using their mobile or AR/VR devices. In some embodiments, standardizing the manner in which the products are displayed (through, for example, standard AR/VR content generation requirements) can permit buyers and sellers to compare products in a remote environment. Some embodiments may better assess product differences by retrieving and storing information about the products. In some embodiments, price estimator 120 may enable the system to quantify complex and subtle differences between products into dollar amounts.

In the foregoing, the terms buyer and seller can be interpreted to include trader and/or dealer as appropriate. In the foregoing, the term seller has been generally used to indicate a user listing something for auction or sale on the platform and the term buyer has been used generally to indicate a user seeking to purchase or bid on a listing. Functionalities generally associated with buyers and sellers are also generally available to traders and dealers.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

FIG. 8 illustrates a schematic diagram of an example computing device suitable for implementing the systems in FIG. 1 according to some embodiments.

For simplicity only one computing device 800 is shown but system may include more computing devices 800 operable by users to access remote network resources 808 and exchange data. The computing devices 800 may be the same or different types of devices. The computing device 800 can include at least one processor 802, a data storage device 804 (including memory, volatile memory, or non-volatile memory, or other data storage elements or a combination thereof), at least one communication interface 806, and at least one network interface 808. The computing device components may be connected in various ways including directly coupled, indirectly coupled (via network interface 808) to a network, and distributed over a wide geographic area and connected to different networks via the network interface 808 (which may be referred to as “cloud computing”).

For example, and without limitation, the computing device may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

FIG. 8 is a schematic diagram of computing device 800, exemplary of an embodiment. As depicted, computing device 800 includes at least one processor 802, memory 804, at least one I/O (or communication) interface 806, and at least one network interface 808.

Each processor 802 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 804 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 806 enables computing device 800 to interconnect with one or more input devices, such as a keyboard, mouse, camera, touch screen and a microphone, or with one or more output devices such as a display screen and a speaker.

Each network interface 808 enables computing device 800 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switched telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Computing device 800 is operable to register and authenticate users (using a login, unique identifier, and password for example) prior to providing access to applications, a local network, network resources, other networks and network security devices. Computing devices 800 may serve one user or multiple users.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only. The scope is indicated by the appended claims.

What is claimed is:

1. A system for an online marketplace for goods and services, the system comprising:
a non-transitory memory storing instructions having an interface for one or more of a seller terminal, a dealer terminal, and a buyer terminal; and
a hardware processor that executes the instructions to:
receive attributes for a product or service from the seller terminal;
process the attributes for the product or service to estimate a condition of the product or service;
generate pricing data for the product or service based on the attributes and the condition of the product or service, wherein the pricing data comprises an estimated price for the product or service;
facilitate a product or service listing using the interface between the seller terminal and at least one of the dealer terminal, and the buyer terminal by generating an electronic listing of the product or service, receiving a plurality of bids or offers, assessing the bids or offers, and determining whether there is an accepted bid or offer for the bids or offers;
update the interface to provide the electronic listing of the product or service and visualizations of the product or service based on the attributes;
generate smart contract code for the product or service in response to receiving confirmation from the seller terminal for the accepted bid or offer;
transmit the smart contract code using the interface; and
collect, normalize and store data for the product or service, the attributes of the product or service, and the pricing data in the memory.

2. The system of claim 1 further comprising a price estimator to:
determine product or service characteristics based in part on the attributes for the product or service;
retrieve historic price data of the product or service with similar characteristics to the product or service characteristics; and
dynamically generate a price based in part on the product or service characteristics and the historic price data.

3. The system of claim 2 further comprising:
a recommendation generator to generate recommendations by processing input data; and
wherein the hardware processor uses the recommendation generator to provide recommendations on acceptance of a bid or offer based on the estimated price for the product or service generated by the system and the attributes for the product or service using the recommendation generator.

4. The system of claim 2, wherein the price estimator generates counteroffers to bids or offers.

5. The system of claim 1, wherein the visualizations of the product or service are provided in an augmented or virtual reality format.

6. The system of claim 1, wherein the hardware processor:
generate product or service characteristics based in part on feedback on the received attributes of the product or service;
automatically diagnose product or service faults based on visual input or images of the product or service, and product or service characteristics;
modify one or more images of the product or service;
update product or service characteristics based on the attributes for the product or service; and
provide feedback on the product or service based in part on the attributes and the diagnosed product or service faults.

7. The system of claim 6, wherein the hardware processor diagnoses product or service faults based on audio input of the product or service.

8. The system of claim 6, wherein the pricing data for the product or service is based in part on the feedback on the product or service.

9. The system of claim 1, further comprising an insurance quote or warranty and sale provider to accept information on a buyer and on the attributes for the product or service to facilitate the quote and sale of insurance or warranty on the product or service to the buyer.

10. The system of claim 1, further comprising a finance and lease provider to accept information on a buyer and on the attributes for the product or service to facilitate the provision of financing options for the product or service to the buyer.

11. A method for an online marketplace, the method comprising:
receiving attributes for a product or service;
processing the attributes for the product or service using a hardware processor;
generating pricing data for the product or service using the hardware processor;
facilitating a product or service listing using an interface between a seller terminal and at least one of a dealer terminal and a buyer terminal by generating an electronic listing of the product or service, receiving a plurality of bids or offers, assessing bids or offers, and determining whether there is an accepted bid or offer;
updating the interface to provide the electronic listing of the product or service and visualizations of the product or service based on the attributes;
generating smart contract code for the product or service in response to receiving confirmation from the seller terminal for the accepted bid or offer;
transmitting the smart contract code using the interface; and
collecting, normalizing and storing data for the product or service, the attributes of the product or service, and the pricing data in the memory.

12. The method of claim 11, wherein the generating pricing data further comprises:
determining the product or service characteristics based in part on the attributes for the product or service;
retrieving historic price data of products or service with similar characteristics to the product or service characteristics; and
dynamically generating a price based in part on the product or service characteristics and the historic price data.

13. The method of claim 12, wherein the assess bids or offers comprises:
providing recommendations on acceptance of a bid or offer based on the attributes for the product or service.

14. The method of claim 12, wherein the method further comprises generating counteroffers to bids or offers.

15. The method of claim 11, wherein the visualizations of the product or service are provided in an augmented or virtual reality format.

16. The method of claim 11, wherein the generating pricing data comprises:
receiving the attributes for the product or service;
diagnosing product or service faults based on visual input of the product or service; and
providing feedback on the product or service based in part on the attributes and the diagnosed product or service faults.

17. The method of claim 16, wherein the generating pricing data further comprises:
diagnosing product or service faults based on audio input of the product or service.

18. The method of claim 16, wherein the pricing data is based in part on the feedback on the product or service.

19. The method of claim 11, further comprising:
accepting information on a buyer; and
facilitating the quote and sale of insurance on the product or service to the buyer.

20. The method of claim 11, further comprising:
accepting information on a buyer; and
facilitating the provision of financing options for the product or service to the buyer.
